(19) United States
(12) Patent Application Publication
(10) Pub. No.: US 2025/0293456 A1
(43) Pub. Date: Sep. 18, 2025

(54) USB CABLE REDUCING ARC DEVICE

(71) Applicant: EASY THINGS CO., LTD, Shenzhen (CN)

(72) Inventor: CHENGLIANG WU, Shenzhen (CN)

(21) Appl. No.: 18/605,569

(22) Filed: Mar. 14, 2024

(51) Int. Cl. H01R 13/53; H01R 13/58

(52) U.S. Cl. CPC H01R 13/53; H01R 13/58

(57) ABSTRACT

The present disclosure discloses a USBC wire ARC device including: a cable body, an interrupt mechanism connecting to an outside of the cable body; a sealing sleeve installing on an outside of one side of the interruption mechanism; a stretching mechanism connecting to an outside of one side of the sealing sleeve; a cable insulation sleeve connecting to an outside of the stretching mechanism. The present disclosure uses a sensor shell, a plug socket, and a limit seat to enable a touch operation of an insulation outer cover plate by the human body first when performing wire inserting and pulling operations; and a human body signal sensor is provided in the sensor shell to indicate whether fingers are in contact with the insulation outer cover of a connector and to determine whether to insert the wire, which may avoid burning the connector.

### TECHNICAL FIELD

The present disclosure relates to the field of USBC wire technologies, and in particular, to a USB cable high voltage plugging and reducing ARC device.

### BACKGROUND

The USB Type-C interface is a hardware interface form of a universal serial bus, and its specifications are published by the USB Developer Forum. The characteristics of the USB Type-C interface are its thinner design, faster transmission speed, and stronger power transmission. More importantly, the Type-C plug-in interface supports double-sided USB interface insertion.

The current TYPEC male and female sockets are paired with load insertion and insertion at 35V or above. Due to the inability to predict when the user will unplug and insert the connector, as well as the speed of unplugging and inserting, it can lead to the generation of ARC (arcing), causing ARC sparks to blacken the terminals, resulting in deformation of the housing. Moreover, after plugging, the cable is often difficult to bend, making it difficult to operate charging devices such as mobile phones, inconvenient to play during charging and long-term bending of cable insertion ends can easily cause cable cracking and damage, thereby affecting the service life and convenience of the wire.

### SUMMARY

A purpose of the present disclosure is to provide a USBC wire high-voltage plugging and reducing ARC device to solve the problem proposed in the background technology.

To achieve the above objectives, the present disclosure provides the following technical solution:
a USBC wire high-voltage plugging and reducing ARC device, including:
a cable body;
an interruption mechanism connecting to an outside of the cable body;
a sealing sleeve providing on an outside of one side of the interruption mechanism;
a stretching mechanism connecting to an outside of one side of the sealing sleeve;
a cable insulation sleeve connecting to an outside of the stretching mechanism; and
a movable mechanism providing in the stretching mechanism.

In an embodiment of the present disclosure, the interruption mechanism includes a sensor shell, an insulation outer cover plate, a plug socket, and a limit seat; the sensor shell is fixedly connected to an outside of one side of the sealing sleeve, an outside of the sensor shell is sleeved with the insulation outer cover plate, an outside of one side of the sensor shell is fixedly connected to the plug socket, an inner of the plug socket is provided with the limit seat; one side of the limit seat is provided with a conductive head.

In an embodiment of the present disclosure, the insulation outer cover plate is sleeved on an outside of the sensor shell, an outer surface of the insulation outer cover plate is a smooth insulation plastic plate, and multiple conductive heads are provided in the plug socket.

In an embodiment of the present disclosure, the stretching mechanism includes a sleeve ring, an insertion groove, and a stretching spring; the sleeve ring is installed on an outside of the sealing sleeve, an interior of the sleeve ring is provided with the insertion groove, an outside of one side of the sleeve ring is fixedly connected to the stretching spring, an internal of the insertion groove is provided with an elastic cable.

In an embodiment of the present disclosure, an outer surface of the elastic cable is a smooth and bendable cable, the elastic cable is fixedly connected to an outside of one side of the cable insulation sleeve, the sleeve ring is elastically connected to the stretching spring for expansion and contraction, the elastic cable penetrates and is inserted into an interior of the movable mechanism and an interior of the sleeve ring.

In an embodiment of the present disclosure, the movable mechanism includes a first rotation sleeve, a first limit column, and a rotation shaft, the first rotation sleeve is fixedly connected to an outside of the stretching spring, an internal of the first rotation sleeve is provided with the first limit column that penetrates and is inserted into the rotation sleeve, an outside of the first limit column is sleeved with the rotation shaft, an interior of the rotation shaft is provided with a second limit column that penetrates and is inserted into the rotation shaft, an inner of the second limit column is sleeved with a second rotation sleeve.

In an embodiment of the present disclosure, the second rotation sleeve is rotationally connected to the second limit column, the first rotation sleeve is rotationally connected to the first limit column, the second limit column and the first limit column are provided in the rotation shaft that penetrate and are inserted into the rotation shaft.

Compared with prior art, the beneficial effects of the present disclosure are:

The present disclosure uses a sensor shell, an insulation outer cover plate, a plug socket, and a limit seat to enable a touch operation of an insulation outer cover plate by the human body first when performing wire inserting and pulling operations, at this time, a human body signal sensor is provided in the sensor shell to indicate whether fingers are in contact with the insulation outer cover of a connector and to determine whether to insert the wire. Before holding an interface, CC (Configuration Channel) communication is interrupted to release CC (Configuration Channel) PIN communication and interrupt charging, and thus CC (Configuration Channel) PIN has no protocol communication, and a working voltage and current are small, which cannot cause ARC to burn the connector.

(2) The present disclosure enables the sealing sleeve to rotate on the stretching mechanism through proving with the sleeve ring, insertion groove, first rotating sleeve, and first limit column, which facilitate the rotation operation of the interruption mechanism after insertion, when bending and stretching an end of the cable, through a rotational connection of the second rotation sleeve on the rotation shaft and a movable rotation of the first rotation sleeve on the rotation shaft, to prevent the bending of the end of the cable from causing cracking and damage to the cable, and through the elastic expansion and contraction of the sleeve ring and stretching spring, the cable can be elastically extended during stretching, thereby increasing the service life of the data cable.

### BRIEF DESCRIPTION OF DRAWINGS

FIG. 1 is a schematic diagram of an overall structure of the present disclosure.

FIG. 2 is a schematic diagram of an overall structure of an interrupt mechanism in FIG. 1 of the present disclosure.

FIG. 3 is a schematic diagram of an overall structure of a stretching mechanism in FIG. 1 of the present disclosure.

FIG. 4 is a schematic diagram of an overall structure of a movable mechanism in FIG. 3 of the present disclosure.

FIG. 5 is a schematic diagram of a principle of a capacitive touch button of the present disclosure.

Numeral reference: 1. Cable body; 2. Interruption mechanism; 201. Sensor shell; 202. Insulation outer cover plate; 203. Plug socket; 204. Limit seat; 205. Conductive head; 3. Sealing sleeve; 4. Stretching mechanism; 401. Sleeve ring; 402. Insertion groove; 403. Stretching spring; 404. Elastic cable; 5. Cable insulation sleeve; 6. Movable mechanism; 601. First rotation sleeve; 602. First limit column; 603. Rotation shaft; 604. Second limit column; 605. Second rotation sleeve.

### DESCRIPTION OF EMBODIMENTS

The following will provide a clear and complete description of the technical solution in the embodiments of the present disclosure, in combination with the drawings. Obviously, the described embodiments are only a part of the embodiments of the present disclosure, not all of them. Based on the embodiments in the present disclosure, all other embodiments obtained by ordinary technicians in the art without creative work fall within the protection scope of the present disclosure.

### EXAMPLE 1

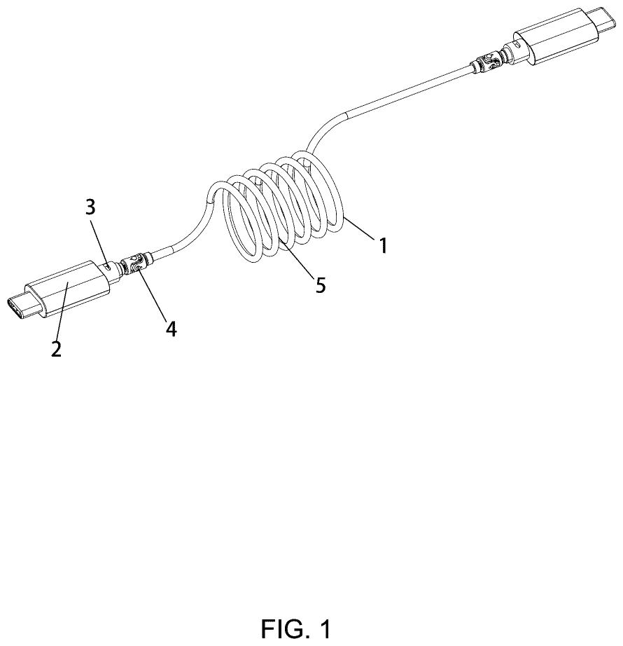

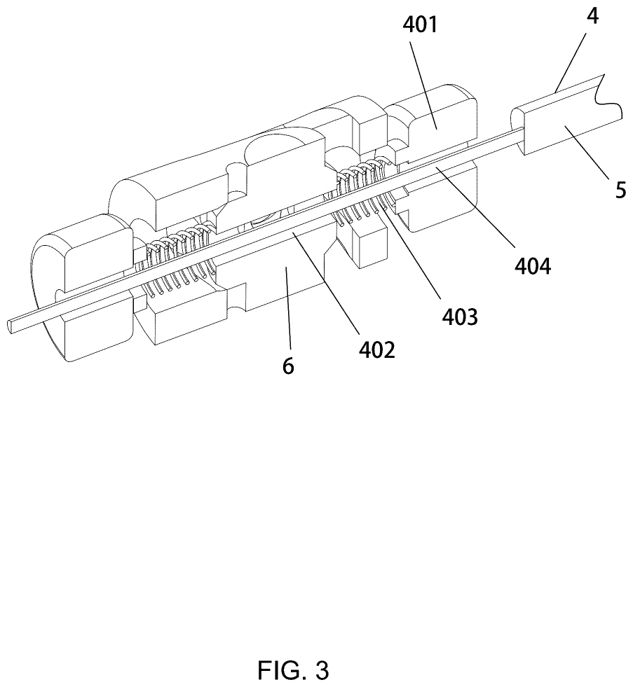

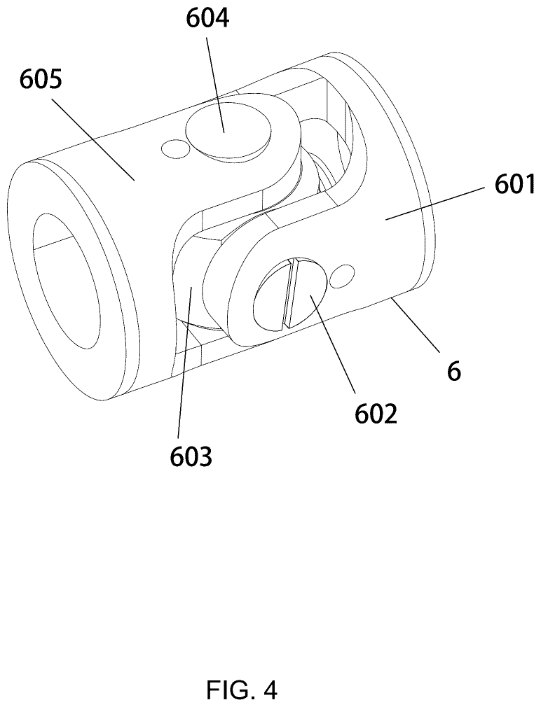

Please refer to FIGS. 1 to 5, a USBC wire high-voltage plugging and reducing ARC device, including:
a cable body 1;
an interruption mechanism 2, which is connected to an outside of the cable body 1;
a sealing sleeve 3, which is provided on an outside of one side of the interruption mechanism 2;
a stretching mechanism 4, which is connected to an outside of one side of the sealing sleeve 3;
a cable insulation sleeve 5, which is connected to an outside of the stretching mechanism 4; and
a movable mechanism 6, which is provided in the stretching mechanism 4.

The interruption mechanism 2 includes a sensor shell 201, an insulation outer cover plate 202, a plug socket 203, and a limit seat 204. The sensor shell 201 is fixedly connected to an outside of one side of the sealing sleeve 3, an outside of the sensor shell 201 is sleeved with the insulation outer cover plate 202. An outside of one side of the sensor shell 201 is fixedly connected to the plug socket 203, an inner of the plug socket 203 is provided with the limit seat 204. A conductive head 205 is provided on one side of the limit seat 204. The insulation outer cover plate 202 is sleeved on an outside of the sensor shell 201, an outer surface of the insulation outer cover plate 202 is a smooth insulation plastic plate. Multiple conductive heads 205 are provided in the plug socket 203.

Specifically, the providing with the limit seat 204 can limit a contact of the plug socket 203 after insertion, thereby increasing a stability of the plug socket 203 after insertion. Moreover, the providing with the insulation outer cover plate 202 can convey instructions for human body signals when touched, interrupt CC communication, and interrupt charging and loading.

As can be seen from the above, when performing wire insertion and extraction operations, the operator first touches the insulation outer cover plate 202. At this time, a human body signal sensor is provided in the sensor shell 201 to indicate whether the finger is in contact with the insulation outer cover of the connector, and to determine whether to connect the wire. Then, before holding the interface with the hand, CC communication can be interrupted, thereby releasing CCPIN communication and interrupting charging, which cannot generate sufficient ARC to burn the connector.

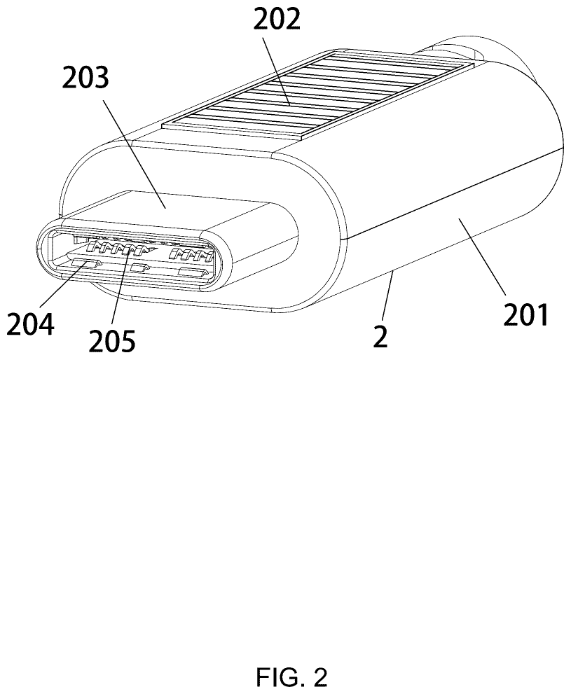

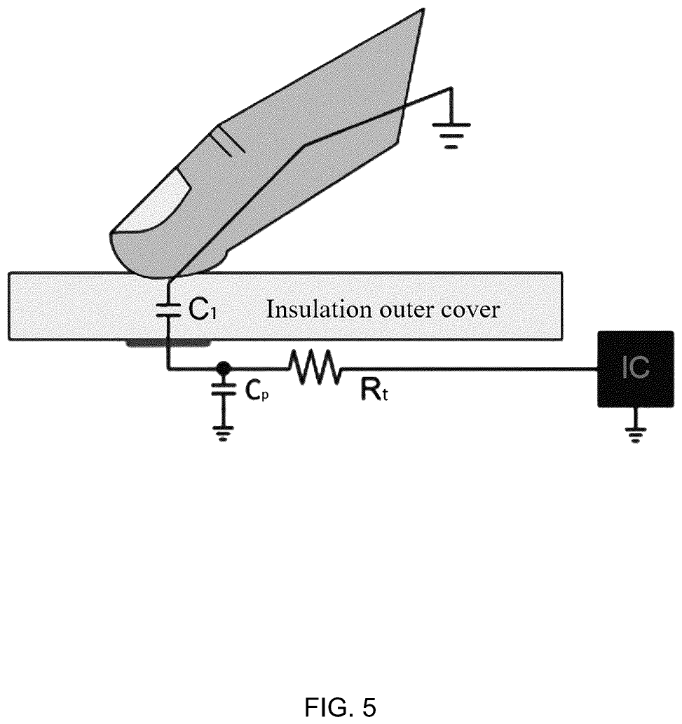

Referring to FIGS. 2 and 5, the stretching mechanism 4 includes a sleeve ring 401, an insertion groove 402, and a stretching spring 403. The sleeve ring 401 is installed on an outside of the sealing sleeve 3, an inner of the sleeve ring 401 is provided with an insertion groove 402. An outside of one side of the sleeve ring 401 is fixedly connected to a stretching spring 403, an inner of the insertion groove 402 is provided with an elastic cable 404. An outer surface of the elastic cable 404 is a smooth and flexible cable, the elastic cable 404 is fixedly connected to an outside of one side of the cable insulation sleeve 5, the sleeve ring 401 is elastically connected to the stretching spring 403 for expansion and contraction. The elastic cable 404 penetrates and is inserted into an interior of the movable mechanism 6 and an interior the sleeve ring 401.

Specifically, by an elastic expansion and contraction between the sleeve ring 401 and the stretching spring 403, it is possible to control a length of the elastic cable 404 during the dragging and stretching the cable insulation sleeve 5, rendering it convenient to control the length of the cable during dragging and stretching.

### EXAMPLE 2

As shown in FIGS. 1 to 5, the movable mechanism 6 includes a first rotation sleeve 601, a first limit column 602, and a rotation shaft 603. The first rotation sleeve 601 is fixedly connected to an outside of the stretching spring 403, an interior of the first rotation sleeve 601 is provided with the first limit column 602 that penetrates and is inserted into the rotation sleeve 601. An outside of the first limit column 602 is sleeved with the rotation shaft 603, an interior of the rotation shaft 603 is provided with a second limit column 604 that penetrates and is inserted into the rotation shaft 603, an inner of the second limit column 604 is sleeved with a second rotation sleeve 605, which is rotationally connected to the second limit column 604. The first rotation sleeve 601 is rotationally connected to the first limit column 602, the second limit column 604 and the first limit column 602 are provided in the rotation shaft 603 that penetrate and are inserted into the rotation shaft 603.

Specifically, by rotating the first rotation sleeve 601 on the first limit column 602, the first rotation sleeve 601 can rotate the rotation shaft 603, and the second rotation sleeve 605 can rotate on the rotation shaft 603 to protect rotation of an end after inserting the cable.

As can be seen from the above, when bending and stretching the end of the cable, the second rotation sleeve 605 is first rotatably connected to the rotation shaft 603, and the first rotation sleeve 601 is rotatably on the rotation shaft 603, which can perform a movable rotation operation of the sealing sleeve 3 on the stretching mechanism 4, facilitating the movable rotation operation of the interruption mechanism 2 after insertion, and preventing the bending of the end of the cable when being inserted from causing the cable to crack and damage, and an elastic expansion and contraction of the sleeve ring 401 and the stretching spring 403 can allow for elastic expansion and contraction of the cable during stretching.

Although embodiments of the present disclosure have been shown and described, it can be understood by those skilled in the art that multiple variations, modifications, substitutions, and variations can be made to these embodiments without departing from the principles and spirit of the present disclosure. The scope of the present disclosure is limited by the claims and their equivalents.

What is claimed is:

1. A USBC wire ARC device, comprising:
a cable body (1);
an interruption mechanism (2), wherein the interruption mechanism (2) is connected to an outside of the cable body (1);
a sealing sleeve (3), wherein the sealing sleeve (3) is provided on an outside of one side of the interruption mechanism (2);
a stretching mechanism (4), wherein the stretching mechanism (4) is connected to an outside of one side of the sealing sleeve (3);
a cable insulation sleeve (5), wherein the cable insulation sleeve (5) is connected to an outside of the stretching mechanism (4); and
a movable mechanism (6), which is provided in the stretching mechanism (4).

2. The USBC wire ARC device according to claim 1, wherein, the interruption mechanism (2) comprises a sensor shell (201), an insulation outer cover plate (202), a plug socket (203), and a limit seat (204); the sensor shell (201) is fixedly connected to an outside of one side of the sealing sleeve (3), an outside of the sensor shell (201) is sleeved with the insulation outer cover plate (202), an outside of one side of the sensor shell (201) is fixedly connected to the plug socket (203), an inner of the plug socket (203) is provided with the limit seat (204); one side of the limit seat (204) is provided with a conductive head (205).

3. The USBC wire ARC device according to claim 2, wherein the insulation outer cover plate (202) is sleeved on an outside of the sensor shell (201), an outer surface of the insulation outer cover plate (202) is a smooth structured insulation plastic plate, and multiple conductive heads (205) are provided in the plug socket (203).

4. The USBC wire ARC device according to claim 1, wherein the stretching mechanism (4) comprises a sleeve ring (401), an insertion groove (402), and a stretching spring (403); the sleeve ring (401) is installed on an outside of the sealing sleeve (3), an interior of the sleeve ring (401) is provided with the insertion groove (402), an outside of one side of the sleeve ring (401) is fixedly connected to the stretching spring (403), an internal of the insertion groove (402) is provided with an elastic cable (404).

5. The USBC wire ARC device according to claim 4, wherein an outer surface of the elastic cable (404) is a smooth and bendable cable, the elastic cable (404) is fixedly connected to an outside of one side of the cable insulation sleeve (5), the sleeve ring (401) is elastically connected to the stretching spring (403) for expansion and contraction, the elastic cable (404) penetrates and is inserted into an interior of the movable mechanism (6) and an interior of the sleeve ring (401).

6. The USBC wire high-voltage ARC device according to claim 1, wherein the movable mechanism (6) comprises a first rotation sleeve (601), a first limit column (602), and a rotation shaft (603), the first rotation sleeve (601) is fixedly connected to an outside of the stretching spring (403), an internal of the first rotation sleeve (601) is provided with the first limit column (602) that penetrates and is inserted into the rotation sleeve (601), an outside of the first limit column (602) is sleeved with the rotation shaft (603), an interior of the rotation shaft (603) is provided with a second limit column (604) that penetrates and is inserted into the rotation shaft (603), an inner of the second limit column (604) is sleeved with a second rotation sleeve (605).

7. The USBC wire ARC device according to claim 6, wherein the second rotation sleeve (605) is rotationally connected to the second limit column (604), the first rotation sleeve (601) is rotationally connected to the first limit column (602), the second limit column (604) and the first limit column (602) are provided in the rotation shaft (603) that penetrate and are inserted into the rotation shaft (603).
